(19) United States
(12) Patent Application Publication
(10) Pub. No.: US 2026/0105255 A1
(43) Pub. Date: Apr. 16, 2026

(54) Semantic Form Processing Using Automated Schema Library Generation

(71) Applicant: Horizon 3 Venture Studio LLC, Los Altos, CA (US)

(72) Inventor: Daniel O'Shea, Miami, FL (US)

(21) Appl. No.: 18/915,160

(22) Filed: Oct. 14, 2024

(51) Int. Cl. G06F 40/30; G06V 30/412

(52) U.S. Cl. CPC G06F 40/30; G06V 30/412

(57) ABSTRACT

Systems and methods for semantic form processing using automated schema library generation are disclosed herein. Form content (including handwritten responses and checkboxes) may be extracted from a filled form, and each step of the extraction may be computer-implemented. The method of extracting data may include generating a schema library for a set of forms and obtaining a schema from the schema library by searching the schema library using the filled form. The schema and a computer-readable encoding of entries of the filled form may be input to a form extraction machine learning model. The form extraction machine learning model may output an encoding of the form content in accordance with the schema. Semantic form processing using automated schema library generation may allow increased efficiency and increased capability in extracting data from forms, as large amounts of training data, machine learning model retraining, and large amounts of preprocessing are not required.

### BACKGROUND

Machine learning models are widely used to automate the processing of forms by identifying and extracting relevant information. These models, often based on natural language processing (NLP) and computer vision techniques, can recognize various elements such as text, numbers, checkboxes, and handwritten entries. Optical character recognition (OCR) systems, powered by machine learning, convert images or scans of forms into machine-readable text. NLP algorithms then analyze this text to understand the structure and meaning, allowing the models to identify key fields like names, addresses, dates, and other pertinent data. By learning from labeled examples, these models improve over time, becoming more accurate in detecting patterns and handling diverse formats, which makes them useful for a wide range of industries, including finance, healthcare, and legal services.

To achieve optimal accuracy in processing forms, machine learning models often require pre-processing steps, including the use of feature detectors and other technologies. These pre-processing techniques help prepare the forms for analysis by enhancing the clarity and structure of the input data. For instance, image enhancement methods like noise reduction, binarization, or skew correction are commonly applied to scanned forms to improve readability. Feature detectors, such as edge detection or contour analysis, can help isolate key sections of the form, such as tables, text boxes, or signature fields, allowing the machine learning model to focus on the relevant areas. In some cases, layout analysis algorithms are employed to understand the spatial arrangement of elements on the form, which is critical for extracting information from non-standardized or complex formats. This pre-processing phase ensures that the models work with clean, well-structured data, increasing the accuracy of information extraction and reducing errors in downstream tasks. However, the use of pre-processing can make trouble shooting the performance of a machine learning model document processing system difficult as the inputs to the machine learning models may not be in human-comprehendible formats and it may be difficult to discern if the machine learning model or the pre-processing systems are the cause of system failure.

Furthermore, despite the efficiency of machine learning models in automating form processing, a key challenge arises when these models encounter new forms or variations that deviate from the data they were originally trained on. Since forms can differ in layout, language, or structure, the models may struggle to accurately identify and extract the required information without additional training. This is especially true in industries where forms frequently change, or new document types are introduced. To address this, models often need to be retrained or fine-tuned on updated datasets to recognize new patterns and fields. While retraining ensures the model remains adaptable, it can be resource-intensive and time-consuming, highlighting the need for more generalizable or dynamic models capable of handling a wider variety of form types without frequent manual intervention.

### SUMMARY

This disclosure relates to semantic form processing systems and more specifically to semantic form processing systems using machine learning models. Semantic form processing systems are disclosed herein which utilize a form data extraction machine learning model that takes in data from an image encoding of a filled form and a schema that defines the data the form is meant to accept, and outputs structured data representing data entered on the filled-out form in accordance with the schema. Accordingly, the semantic form processing systems can be used to obtain structured data from images of filled forms.

In specific embodiments, the semantic form processing system can be configured in a setup stage and utilized in a deployment stage. The setup stage can be separate and apart from a training stage in which the machine learning model, or models, used by the semantic form processing system are trained. Indeed, in accordance with specific embodiments disclosed herein, the setup stage can be conducted without the need for any machine learning model training. During the setup stage, a schema library generator model can be used to produce a library of schemas that can be utilized in the deployment stage. The library of schemas can include a set of schema indexes and a corresponding set of schemas. The library of schemas can be utilized in the deployment stage by a schema identification machine learning model which selects a schema from the library and provides it to the form data extraction machine learning model.

In specific embodiments of the invention, the form extraction machine learning models disclosed herein are designed to accept a computer-readable encoding of a schema and a computer-readable encoding of the entries of a filled form as direct inputs to the machine learning model and to output the content of the form as structured data in accordance with that schema. The computer-readable encoding can be an encoding of the image of the filled form or an encoding of entries extracted from the filled form such as by using a document model analyzer. Accordingly, the machine learning model does not require any preprocessing of the form into a feature space that is not human readable. Furthermore, the schema can be presented in a format that is both human readable as well as machine readable (e.g., a JavaScript object notation (JSON) file). As such, the machine learning model can be efficiently integrated into an enterprise grade form processing pipeline as all of the direct inputs and the output of the machine learning model are understandable to a human reviewer, and the reviewer can immediately determine if the machine learning model itself is malfunctioning and needs to be retrained, as opposed to needing to conduct more in-depth trouble shooting and determine if a pre-processing module or other subsystem is at fault. For example, if the reviewer sees that they could not have accurately determined the content of a form field, the reviewer will be able to immediately verify that the performance of the model should not be found defective in its current state, and if the reviewer sees that they could have accurately determined the content of the form field, the performance of the model can be found defective in its current state and a retraining process can be conducted in response to improve the performance.

In specific embodiments of the invention, the form processing system is fully extensible for any sized library of schemas as it is not trained on specific forms but is instead trained to harvest data in accordance with schemas generally. Modern machine learning systems can cost millions or tens of millions of dollars to train. Accordingly, significant benefits accrue to applications of machine learning models that are extensible without needing to retrain the models in the system. In specific embodiments of the invention, the form data extraction model is trained to accept filled forms generally and does not need to have been trained on a specific form previously. In specific embodiments, the form data extraction model simply needs a schema for a form, and an image of the filled form. Furthermore, specific embodiments disclosed below include a schema identification model and a schema library generator model which are trained to, respectively, determine similarities between forms generally, and to determine schemas for forms generally. The schema library generator model can generate a set of embedding vectors for a set of unfilled forms. The set of embedding vectors can be used as the set of schema indexes for the library. In specific embodiments, the schema library generator model can also generate the schemas for the set of unfilled forms. However, in alternative embodiments, different models can conduct each of those tasks. The schema identification model can generate an embedding vector for a filled form which can be used in a comparison with the set of schema indexes to find a schema for the filled forms. The aforementioned models do not need to be trained with respect to a specific form for the overall system to be able to process specific forms accurately. Instead, all that is required is for the form to be run through the schema library generator model during a setup phase, and the resulting automatically harvested schema can be added to the schema library. Accordingly, the overall form processing system increases in capability through the execution of a single inference per additional form as opposed to the numerous training inferences required to train a form data extraction model for a specific form, and the overhead associated with a training session generally.

This disclosure is directed to technical solutions to the technical problem of extracting machine-readable data in accordance with a schema from unstructured data as provided in human-readable form. The technical solutions disclosed herein include providing a machine learning model that can accept a schema and an image encoding of a filled document directly as input without any preprocessing, providing a machine learning model that can find that schema in a library of schemas using the filled form, and an automated process for building that library of schemas based on a large collection of forms using another machine learning model. In specific embodiments, the technical solution includes providing a system that does not require retraining of a machine learning model when a new form is introduced to accurately retrieve structured data from specific instances of the new form. Instead, in specific embodiments, all that is required is a new schema to be generated for the new form. Furthermore, in specific embodiments, the new schema can be generated in an automated fashion.

In specific embodiments of the invention, a semantic form processing method to extract form content from a filled form, in which each step is computer-implemented, is provided. The method comprises: generating a schema library for a set of forms, obtaining a schema from the schema library by searching the schema library using the filled form, providing the schema as a first input to a form extraction machine learning model, providing a computer-readable encoding of entries of the filled form as a second input to the form extraction machine learning model, and receiving an output from the form extraction machine learning model, wherein the output from the form extraction machine learning model is an encoding of the form content in accordance with the schema.

In specific embodiments of the invention, one or more non-transitory computer-readable media storing instructions, which when executed by one or more processors cause the one or more processors to conduct a method to extract form content from a filled form, in which each step is computer-implemented, is provided. The method comprises: generating a schema library for a set of forms, obtaining a schema from the schema library by searching the schema library using the filled form, providing the schema as a first input to a form extraction machine learning model, providing a computer-readable encoding of entries of the filled form as a second input to the form extraction machine learning model, and receiving an output from the form extraction machine learning model, wherein the output from the form extraction machine learning model is an encoding of the form content in accordance with the schema.

In specific embodiments of the invention, a system for extracting form content from a filled form, in which each step is computer-implemented, is provided. The system comprises: a means for generating a schema library for a set of forms, a means for obtaining a schema from the schema library by searching the schema library using the filled form, a means for providing the schema as a first input to a form extraction machine learning model, a means for providing a computer-readable encoding of entries of the filled form as a second input to the form extraction machine learning model, and a means for receiving an output from the form extraction machine learning model, wherein the output from the form extraction machine learning model is an encoding of the form content in accordance with the schema.

### BRIEF DESCRIPTION OF THE DRAWINGS

The accompanying drawings illustrate various embodiments of systems, methods, and various other aspects of the disclosure. A person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 provides a process of semantic form processing using automated schema library generation in accordance with specific embodiments of the inventions disclosed herein.

FIG. 2 provides an example process of generating a library of schemas from unfilled forms in accordance with specific embodiments of the inventions disclosed herein.

FIG. 3 provides an example of a process for obtaining data from a filled form including a process for searching the library of schemas to select a schema and a process for using the selected schema to convert the image of the filled form to structured data in accordance with specific embodiments of the inventions disclosed herein.

FIG. 4 provides an example of a process for adding a new schema to a schema library to form an updated schema library in accordance with specific embodiments of the inventions disclosed herein.

FIG. 5 provides an example of a process of selecting a schema from a set of candidate schemas in accordance with specific embodiments of the inventions disclosed herein.

FIG. 6 provides examples of unfilled forms that schemas in a schema library may be based on in accordance with specific embodiments of the inventions disclosed herein.

FIG. 7 provides an example of a method of semantic form processing to extract form content from a filled form in accordance with specific embodiments of the inventions disclosed herein.

FIG. 8 provides an example of a method for obtaining a schema from a schema library in accordance with specific embodiments of the inventions disclosed herein.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Different systems and methods for semantic form processing in accordance with the summary above are described in detail in this disclosure. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

Specific embodiments of the invention will be described with reference to a form processing system as that term is used in the summary above. An embodiment of the form processing system includes a collection of libraries, code bases, and software modules which are implemented in hardware to conduct the document processing methods disclosed herein. A form processing system can include all components disclosed herein including those used in both the setup and the deployment phases in order to execute the semantic form processing methods disclosed herein.

The form processing systems disclosed herein can be applied to extract data from various forms commonly used in business operations. These include structured documents like receipts, checks, tax forms, invoices, and purchase orders, where data follows a consistent layout. Additionally, the approaches disclosed herein can be applied to obtain data from documents like contracts, insurance claims, and legal documents containing identifiable sections or patterns, which the machine learning models can parse to extract relevant data, such as contract terms, policy numbers, or party names. As a specific example, the systems can be used to identify modifications to stock legal agreements that have been modified slightly for specific counterparties. The systems can be used to process forms of varying degrees of complexity. The systems can be used to process basic forms such as checks. The systems can be used to process complex forms such as W-2s, 1099s, or tax returns for tax purposes, identifying pertinent information like income, tax withholdings, and deductions. These models streamline data extraction across diverse document types, ensuring efficiency and accuracy in large-scale enterprise workflows. The systems disclosed herein exhibit great benefits in terms of both their accuracy and extensibility so a given enterprise workflow could easily be updated to accommodate new forms such as purchase orders or checks from a new affiliate or forms that have been updated from old versions.

The forms can be encoded as computer-readable images. The computer-readable image formats could include Joint Photographic Experts Group (JPEG), Portable Network Graphics (PNG), Graphics Interchange Format (GIF), Bitmap (BMP), Scalable Vector Graphics (SVG), or other formats. The formats could be supported by modern browsers and software. The encoding could be provided to the machine learning models disclosed herein directly with the computer-readable binary or alpha-numeric values for the image provided as inputs to the first layer of the machine learning models.

Schemas are structured frameworks or blueprints that define the organization and relationships of data within a system. When applied to forms, a schema describes the layout and content that a filled-out form should contain. For example, in an online registration form, a schema may specify the types of fields (e.g., name, email, password), the data types (e.g., text, email format, alphanumeric for passwords), and any constraints (e.g., mandatory fields, length restrictions, or specific formats like a valid email address). The schema ensures that the form captures all the required information in a consistent manner and that the data conforms to the expected rules. In practice, this might be implemented using technologies like JSON Schema, which defines how data should be structured in JSON format, or extensible markup language (XML) schemas for XML data. Schemas not only validate that the form data is properly filled out but also ensure the correct processing, storage, and interpretation of the information once it's submitted.

Semantic form processing systems are disclosed herein which utilize a form data extraction machine learning model that takes in data from an image encoding of a filled form and a schema that defines the data the form is meant to accept, and outputs structured data representing data entered on the filled-out form in accordance with the schema. Accordingly, the semantic form processing systems can be used to obtain structured data from images of filled forms.

In specific embodiments, the semantic form processing system can be configured in a setup stage and utilized in a deployment stage. The setup stage can be separate and apart from a training stage in which the machine learning model, or models, used by the semantic form processing system are trained. Indeed, in accordance with specific embodiments disclosed herein, the setup stage can be conducted without the need for any machine learning model training. During the setup stage, a schema library generator model can be used to produce a library of schemas that can be utilized in the deployment stage. The library of schemas can include a set of schema indexes and a corresponding set of schemas. The library of schemas can be utilized in the deployment stage by a schema identification machine learning model which selects a schema from the library and provides it to the form data extraction machine learning model.

The schemas can be stored and manipulated by the system in various ways depending on the database or system architecture. If the system utilized relational databases, the schemas could be stored in a data dictionary and describe tables, columns, data types, constraints, and relationships between the tables. These schemas could be manipulated using Structured Query Language (SQL) to modify, update, or query the structure. If the system utilized object-oriented databases, the schemas could correspond to class definitions of objects and could be manipulated through object-oriented programming (OOP) principles. In XML databases or data interchange formats, the schemas could be stored using XML Schema Definitions (XSD) or Document Type Definitions (DTD) and manipulated using XML Path Language (XPath) or XML Query (XQuery). In all cases, schema evolution and versioning techniques could allow for changes to the schemas to be managed over time without disrupting the system.

The schemas may be encoded as vectors using an embedding algorithm. In many situations, form pages have titles and field names that are the same regardless of the information entered into the form. This consistency in titles and field names allows an approximate nearest neighbor search to find a set of candidate schemas for a filled out form. This set of candidate schemas may be input to a large language model (LLM) that then selects the best option (e.g., closest schema) based on the encoding of the raw image representing the filled out form page.

In specific embodiments of the invention, the form extraction machine learning models disclosed herein are designed to accept a computer-readable encoding of a schema and a computer-readable encoding of the entries of a filled form as direct inputs to the machine learning model and to output the content of the form as structured data in accordance with that schema. The computer-readable encoding can be an encoding of the image of the filled form or an encoding of entries extracted from the filled form such as by using a document model analyzer. Accordingly, the machine learning model does not require any preprocessing of the form into a feature space that is not human readable. Furthermore, the schema can be presented in a format that is both human readable as well as machine readable (e.g., a JSON file). As such, the machine learning model can be efficiently integrated into an enterprise grade form processing pipeline as all of the direct inputs and the output of the machine learning model are understandable to a human reviewer, and the reviewer can immediately determine if the machine learning model itself is malfunctioning and needs to be retrained, as opposed to needing to conduct more in-depth trouble shooting and determine if a pre-processing module or other subsystem is at fault. For example, if the reviewer sees that they could not have accurately determined the content of a form field, the reviewer will be able to immediately verify that the performance of the model should not be found defective in its current state, and if the reviewer sees that they could have accurately determined the content of the form field, the performance of the model can be found defective in its current state and a retraining process can be conducted in response to improve the performance.

In specific embodiments of the invention, the form processing system is fully extensible for any sized library of schemas as it is not trained on specific forms but is instead trained to harvest data in accordance with schemas generally. Modern machine learning systems can cost millions or tens of millions of dollars to train. Accordingly, significant benefits accrue to applications of machine learning models that are extensible without needing to retrain the models in the system. In specific embodiments of the invention, the form data extraction model is trained to accept filled forms generally and does not need to have been trained on a specific form previously. In specific embodiments, the form data extraction model simply needs a schema for a form, and an image of the filled form. Furthermore, specific embodiments disclosed below include a schema identification model and a schema library generator model which are trained to, respectively, determine similarities between forms generally, and to determine schemas for forms generally. The schema library generator model can generate a set of embedding vectors for a set of unfilled forms. The set of embedding vectors can be used as the set of schema indexes for the library. In specific embodiments, the schema library generator model can also generate the schemas for the set of unfilled forms. However, in alternative embodiments, different models can conduct each of those tasks. The schema identification model can generate an embedding vector for a filled form which can be used in a comparison with the set of schema indexes to find a schema for the filled forms. The aforementioned models do not need to be trained with respect to a specific form for the overall system to be able to process specific forms accurately. Instead, all that is required is for the form to be run through the schema library generator model during a setup phase, and the resulting automatically harvested schema can be added to the schema library. Accordingly, the overall form processing system increases in capability through the execution of a single inference per additional form as opposed to the numerous training inferences required to train a prior art form data extraction model for a specific form, and the overhead associated with a training session generally.

The processes and systems disclosed herein may use a variety of machine learning systems. For example, a schema identification model may produce an embedding vector that describes the form. In specific embodiments, a separate, non-machine learning model, system may conduct a nearest neighbor analysis of the field of vectors to determine which schema is implicated. A form data extraction model may be a machine learning model (e.g., LLM) that takes an image file of the filled form and a schema (e.g., a JSON schema). A machine learning model may perform a schema search. The search may be performed by generating a binary encoded vector for a filled out page in a form. The binary encoded vector may then be used in a vector similarity search to find the best schema to match the page. As a final output, the collection of machine learning models and other features may produce a structured JSON response of the data in the filled out form according to the best matching schema.

This disclosure is directed to technical solutions to the technical problem of extracting machine-readable data in accordance with a schema from unstructured data as provided in human-readable form. The technical solutions disclosed herein include providing a machine learning model that can accept a schema and an image encoding of a filled document directly as input without any preprocessing, providing a machine learning model that can find that schema in a library of schemas using the filled form, and an automated process for building that library of schemas based on a large collection of forms using another machine learning model. In specific embodiments, the technical solution includes providing a system that does not require retraining of a machine learning model when a new form is introduced to accurately retrieve structured data from specific instances of the new form. Instead, in specific embodiments, all that is required is a new schema to be generated for the new form. Furthermore, in specific embodiments, the new schema can be generated in an automated fashion.

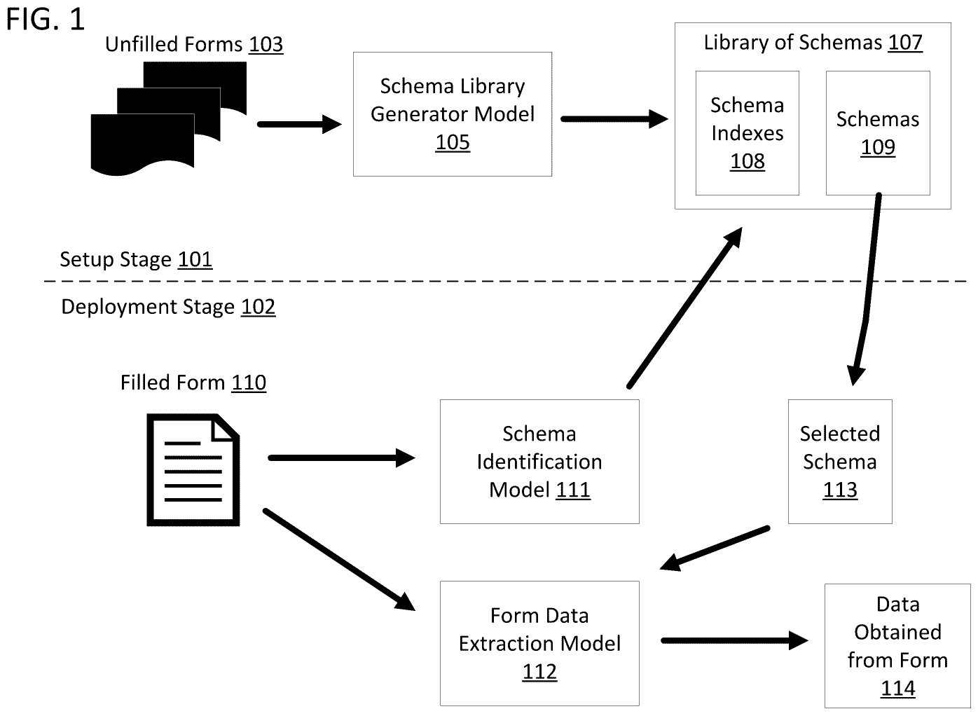

FIG. 1 depicts process 100 of semantic form processing using automated schema library generation. Process 100 includes setup stage 101 and deployment stage 102. Setup stage 101 includes a set of unfilled forms 103, schema library generator model 105, and library of schemas 107 (which includes schema indexes 108 and schemas 109). Deployment stage 102 includes filled form 110, schema identification model 111, form data extraction model 112, selected schema 113, and data 114 obtained from filled form 110. Schema identification model 111 may also be referred to as a schema selection identification model. Form data extraction model 112 may also be referred to as a form extraction machine learning model. Data 114 may also be referred to as form content.

Schema library generator model 105 may identify patterns for which types of data are included in each unfilled form 103 and where that data is located in that unfilled form 103 to generate library of schemas 107. Library of schemas 107 may include schemas 109 and corresponding schema indexes 108. Each schema index 108 may link to (e.g., be a key for) a schema 109. Schema identification model 111 may identify a schema related to filled form 110 by comparing embedding vectors of filled form 110 to embedding vectors of schemas 109. The embedding vectors can be the schema indexes 108. The schema library generator model 105 and schema identification model 111 may both be configured to generate an embedding vector for a provided form in order to facilitate the search of library of schemas 107 for a schema of filled form 110. Schema identification model 111 may select a schema 109 (to be selected schema 113) via the corresponding schema index 108 of that schema 109. Selected schema 113 may be input to form data extraction model 112. Form data extraction model 112 may use selected schema 113 and filled form 110 as inputs to parse filled form 110 to extract data 114.

Process 100 may be applied to extract data from various forms commonly used in business operations. Unfilled forms 103 may be templates of a variety of forms (unfilled forms do not have user responses) and may be separated into individual pages (e.g., when a form includes multiple pages). Unfilled forms 103 may include structured documents where data follows a consistent layout, for example receipts, checks, tax forms, invoices, or purchase orders. Unfilled forms 103 may also include documents containing identifiable sections or patterns such as contracts, insurance claims, or legal documents. Process 100 may be able to identify pertinent information from forms of varying degrees of complexity. For example, unfilled forms 103 may include basic forms such as checks or complex forms such as tax returns.

Unfilled forms 103 can be encoded as computer-readable images. The computer-readable image formats could include JPEG, PNG, GIF, BMP, SVG, or other formats. The formats may be supported by modern browsers and software. The encoding may be provided to the machine learning models (e.g., schema library generator model 105) disclosed herein directly with the computer-readable binary or alpha-numeric values for the image provided as inputs to the first layer of the machine learning models.

Schema library generator model 105 may be a machine learning model that identifies patterns for which types of data are included in each unfilled form 103, identifies where that data is located in the unfilled form 103, and generates a schema 109 for that unfilled form 103 based on the included data and data locations. Schema library generator model 105 may also generate a schema index 108 for each schema 109 to label, refer to, or identify schemas 109. Generating library of schemas 107 may include generating a set of embedding vectors for the set of unfilled forms 103 by applying a set of computer-readable encodings of a set of images of the set of unfilled forms 103 to schema library generator model 105.

In specific embodiments, schema library generator model 105 may update library of schemas 107, without being retrained (and after process 100 outputs data 114). That is, schema library generator model 105 may generate an updated schema library without schema library generator model 105 being retrained. The update to library of schemas 107 may include an additional schema generated using an unfilled version of an additional form (e.g., an additional unfilled form not previously associated with a schema).

Schemas are structured frameworks or blueprints that define the organization and relationships of data within a system. When applied to forms, a schema describes the layout and content that a filled-out form such as filled form 110 may contain. For example, a schema may specify the types of fields (e.g., name, email, phone number, identification number), the data types (e.g., text, email format, numeric, alphanumeric), and any constraints (e.g., mandatory fields, length restrictions, or specific formats like a valid email address). The schema ensures that the form captures all the required information in a consistent manner and that the data conforms to the expected rules. Schemas may validate that form data (e.g., from filled form 110) is properly filled out and may ensure the correct processing, storage, and interpretation of the information once it's submitted.

Library of schemas 107 may store schemas 109 and schema indexes 108 generated by schema library generator model 105. Schemas 109 may be encoded as vectors using an embedding algorithm. Schemas 109 may be implemented using technologies like JSON schema or XML schema, which define how data should be structured in JSON format or XML data respectively. Schemas 109 may be both human-readable and machine-readable and may be in text format.

Schemas 109 may be stored and manipulated by the system in various ways depending on the database or system architecture. If the system utilized relational databases, the schemas could be stored in a data dictionary and describe tables, columns, data types, constraints, and relationships between the tables. In this case, schemas 109 could be manipulated using Structured Query Language (SQL) to modify, update, or query the structure. If the system utilized object-oriented databases, then schemas 109 could correspond to class definitions of objects and could be manipulated through object-oriented programming (OOP) principles. In XML databases or data interchange formats, schemas 109 may be stored using XML Schema Definitions (XSD) or Document Type Definitions (DTD) and manipulated using XPath or XQuery. In many cases, schema evolution and versioning techniques could allow for changes to the schema 109 to be managed over time without disrupting the system.

Filled form 110 may be a filled version of any one of the unfilled forms 103 and may have a corresponding schema 109 in the library of schemas 107. Filled form 110 may be an image of a handwritten document, typed document, or a mixture of handwriting and type, and may be separated into individual pages (e.g., when a form constitutes multiple pages). Filled form 110 may be encoded as a computer-readable image and may be in any format that unfilled forms 103 may be in, such as JPEG, PNG, GIF, BMP, SVG, or other formats. The encoding of filled form 110 may be provided to the machine learning models (e.g., schema identification model 111 and form data extraction model 112) disclosed herein directly with the computer-readable binary or alpha-numeric values for the image provided as inputs to the first layer of the machine learning models.

Schema identification model 111 may identify a schema (e.g., selected schema 113) related to filled form 110 via a schema index 108 of that schema. Selected schema 113 may be encoded as JSON format and may be both human-readable and machine-readable. Searching library of schemas 107 may include generating an embedding vector for filled form 110 by applying a computer-readable encoding of an image of filled form 110 to schema identification model 111. Schema identification model 111 may generate a binary encoded vector for a filled form 110. The binary encoded vector may then be used in a vector similarity search to find the best schema to match the page. In many situations, form pages (e.g., filled forms 110) have titles and field names that are the same regardless of the information entered into the form. This consistency across pages and forms facilitates an approximate nearest neighbor search among schemas to identify selected schema 113 as a match for filled form 110.

In specific embodiments, a nearest neighbor analysis may be conducted using the set of embedding vectors of schemas 109 and the embedding vector of filled form 110. In specific embodiments, there may be many schemas 109 with embedding vectors close to the embedding vectors of filled form 110. In these embodiments, a set of candidate schemas may be input to schema identification model 111 (which may be a machine language model such as an LLM). Schema identification model 111 may select the best schema 109 (e.g., closest match) to be selected schema 113 based on the encoding of the raw image representing the filled form 110. In specific embodiments, schema identification model may output selected schema 113.

Selected schema 113 may be in text format and may be human-readable. Selected schema 113 may be stored using extensible markup language (XML) schema definitions or document type definitions. Selected schema 113 may be manipulated using XML path language or XML query.

While schema identification model 111 and schema library generator model 105 share similarities in that, in specific embodiments, they both generate embedding vectors for provided forms, they are not identical in specific embodiments. Schema identification model 111 may receive filled forms 110 as inputs, which may not be formatted consistently (e.g., mix of type and handwritten entries, mix of checkboxes and sentence responses, etc.) and may be trained to identify the underlying form while ignoring the entries. In contrast, schema library generator model 105 may receive unfilled forms 103 as an input and may therefore be trained to review all of the data available on the form and to expect data with low noise generally.

Form data extraction model 112 may be a machine learning model. Form data extraction model 112 may use selected schema 113 to parse filled form 110 to extract data 114. Form data extraction model 112 may be a machine learning model. Form data extraction model 112 may be an LLM and be designed to receive a textual encoding of filled form 110 (e.g., either a binary or alphanumeric encoding of the image of filled form 110, or a textual encoding of the entries of the filled form). A computer-readable encoding of entries of filled form 110 may be input to form data extraction model 112. The computer-readable encoding of the entries of filled form 110 may comprise a textual encoding of an image of filled form 110. A set of structured or semi-structured data of filled form 110 may be provided as an input to form data extraction model 112 and may be in text format and may be human-readable. In specific embodiments the structured or semi-structured data can include both an encoding of the entries on filled form 110 and a schema for that data that can be used in combination with the schema for the form stored in library of schemas 107 to cross check system.

Data 114, which is output from form data extraction model 112, may be generated using selected schema 113, a computer-readable encoding of entries of filled form 110, and a set of structured or semi-structured data from filled form 110 (which were all input to form data extraction model 112). Data 114 may be an encoding of the content of filled form 110 in accordance with selected schema 113. Data 114 may be in a machine-readable format and in a human-readable format. Data 114 may be a structured JSON response (e.g., structured JSON format) corresponding to information in filled form 110 according to selected schema 113. Data 114 may include information such as names, ages, phone numbers, addresses, dates, birthdays, emails, and more.

Process 100 may be repeated to extract data from various filled forms. Library of schemas 107 may be updated to include additional schemas corresponding to additional unfilled forms (without schema library generator model 105 being retrained). Process 100 may streamline data extraction across diverse document types, ensuring efficiency and accuracy in large-scale enterprise workflows. Process 100 exhibits great benefits in terms of both accuracy and extensibility as a given enterprise workflow could easily be updated to accommodate new forms such as purchase orders or checks from a new affiliate or forms that have been updated from old versions.

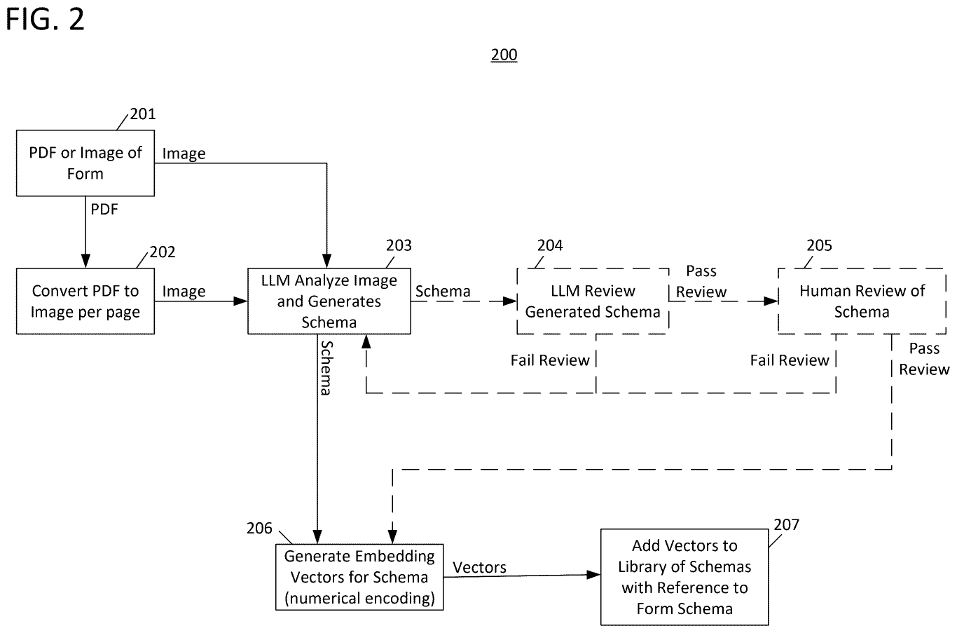

FIG. 2 depicts an example process 200 of generating a library of schemas from unfilled forms. Process 200 may be performed by a system including one or more machine learning models. In different embodiments, steps of process 200 may be omitted, duplicated, rearranged, or otherwise deviate from the form shown. Process 200 may relate to setup stage 101 of FIG. 1.

At step 201, a PDF or image of an unfilled form may be input into the system. If the unfilled form is in PDF format (or another non-image format), then at step 202, the form may be converted into an image format (e.g., JPEG, PNG, GIF, BMP, SVG). The image format may include a binary or alphanumeric encoding so that it can be provided as direct input to an LLM in that form.

At step 203, the image (e.g., directly from step 201 of reformatted at step 202) of the unfilled form may be input to a machine learning model, such as an LLM, that analyzes the image and generates a schema based on the image. The schema may be used as an input to step 204 and to step 206.

In specific embodiments, at step 204, the schema may be reviewed by the same LLM that generated the schema at step 203. Step 204 is an optional feature where the LLM critiques how well it did at generating the schema. Accordingly, in specific embodiments, step 204 may be omitted. If the schema fails the review, then the LLM may analyze the image and generate another schema (e.g., repeat step 203). The updated schema may be based on the previous schema or may be remade directly from the image of the unfilled form. The process may loop between step 204 and step 203 until the schema passes the review. If the schema is updated (e.g., fails the review at step 204 at least once), then it may be the updated schema (opposed to the original schema) that is input at step 206. In additional iterations of step 203 the critique output by step 204 may be provided as an additional text input to the machine learning model along with the original image.

In specific embodiments, at step 205, a human (e.g., user, programmer) may review the schema. Step 205 may be performed even if step 204 is omitted (e.g., step 203 may proceed directly to step 205). In specific embodiments, step 205 may occur before step 204. Step 205 is an optional feature that may be omitted in specific embodiments. At step 205, one or more humans may critique how well the LLM generated the schema (e.g., at step 203) and/or how well the LLM critiqued itself (e.g., at step 204). If the schema fails the human review, then the process may return to step 203 (e.g., the LLM may analyze the image and generate another schema). In specific embodiments, the LLM may learn from the verdict of the human review to improve its own critiquing functions. If the schema passes the human review, then the schema may be input to step 206. In additional iterations of step 203 a critique generated by a human reviewer and output by step 205 may be provided as an additional text input to the machine learning model along with the original image.

At step 206, embedding vectors may be generated for the schema (e.g., produced at step 203). The embedding vectors may be in the form of numerical encodings. Embedding vectors may indexed to the schema of the unfilled form. In specific embodiments, the schema passes an LLM review at step 204 before being input to step 206. In specific embodiments, the schema passes a human review at step 205 before being input to step 206. In specific embodiments, the schema does not undergo reviews and is input to step 206 directly after being generated at step 203. In any case, the schema may be input to step 206 once, directly after any one of step 203, step 204, or step 205.

At step 207, the embedding vectors generated at step 206 may be added to a library of schemas. The embedding vectors may be tagged, labeled, or otherwise include reference to the schema the embedding vectors describe. A set of embedding vectors may act as an index to a schema. The schema may correspond to a specific unfilled form.

Process 200 may be repeated to add multiple schemas related to multiple forms into a library of schemas. Additionally, process 200 may be repeated after data has been extracted from a filled form using the schemas, such that the library of schemas may be updated to include additional schemas corresponding to additional unfilled forms without the LLM being retrained. Process 200 may streamline data extraction across diverse document types, ensuring efficiency and accuracy in large-scale enterprise workflows. Process 200 exhibits great benefits in terms of both accuracy and extensibility as a given enterprise workflow could easily be updated to accommodate new forms such as purchase orders or checks from a new affiliate or forms that have been updated from old versions.

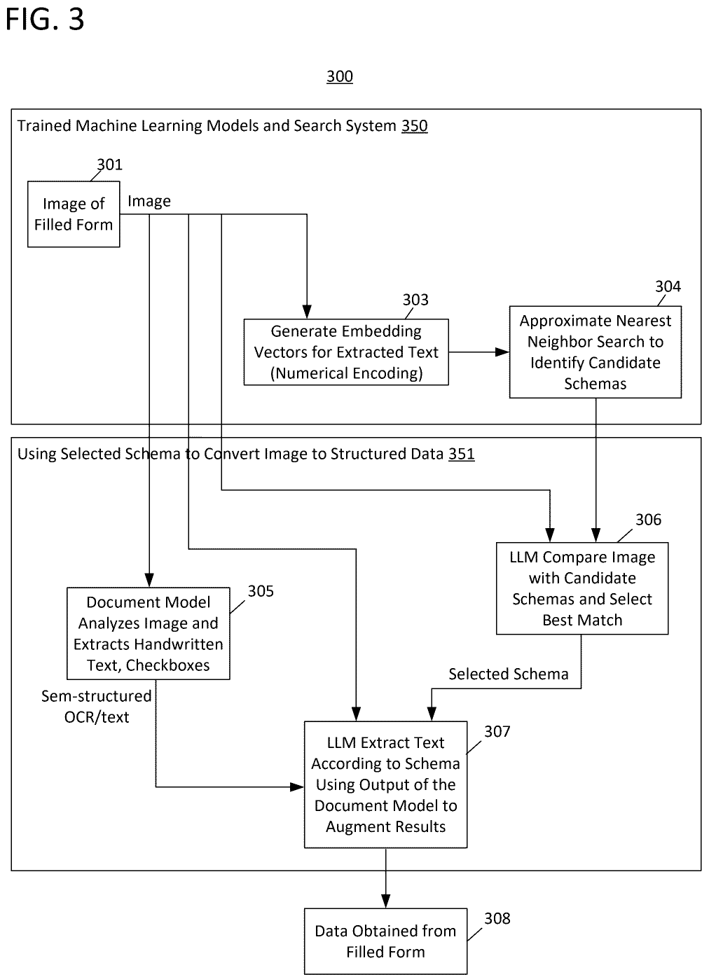

FIG. 3 depicts an example of process 300 for obtaining data from a filled form. Process 300 includes process 350 for searching the library of schemas (e.g., the library of schemas being set up using process 200 of FIG. 2) to select a schema and process 351 for using the selected schema to convert the image of the filled form to structured data. Process 300 may be performed by a system including one or more machine learning models. In different embodiments, steps of process 300 may be omitted, duplicated, rearranged, or otherwise deviate from the form shown. Process 300 may relate to deployment stage 102 of FIG. 1.

At step 301, an image of the filled form may be provided. If the filled form is provided in PDF format or another non-image format, the filled form may be converted to an image format. Each page of the filled form may be a separate image. The image may be provided to various subsystems of process 300, e.g., as an input to steps 303, 305, 306, and 307.

At step 303, embedding vectors for extracted text may be generated. The embedding vectors may be based on the image of the filled form and may be numerically encoded. The image of the filled form may be an input of a machine learning model (such as an LLM) that outputs the embedding vectors.

In specific embodiments, at step 304, the embedding vectors (e.g., generated at step 303) may be used to perform an approximate nearest neighbor search to identify candidate schemas. Embedding vectors may be an input to a machine learning model (such as an LLM) performing the nearest neighbor search and a set of candidate schemas may be an output of the LLM.

At step 306, a machine learning model (such as an LLM) may compare the image of the filled form (e.g., from step 301) with candidate schemas (e.g., identified at step 304) and select a schema that best matches the filled form. The nearest neighbor search performed at step 304 may be approximate and thus further narrowing schemas from a set of candidate schemas to a single selected schema may be necessary. The image and candidate schemas are inputs to the LLM used in step 306 and the selected schema is an output of the LLM used in step 306. In specific embodiments, selecting a schema from the set of candidate schemas may be moot as only one candidate schema is identified. However, in specific embodiments, selecting a schema from the set of candidate schemas may be valuable as the set of candidate schemas may include any number or (e.g., more than one) schemas.

Selecting a schema improves accuracy for extracting data from forms (e.g., at step 307). Different forms often use different headings for the same information, by using the correct schema for the filled form, the LLM is able to identify which heading to look for. For example, a schema might indicate that “gender” is a heading, opposed to “sex”. The schema may tell the LLM what to look for in a form and may make the act of extracting information from filled forms more consistent. Additionally, selection of a schema may be valuable as the schema provides more guidance for the LLM of step 307, which may perform better with a specific task rather than a general task.

At step 305, a document model (e.g., a machine learning model) may analyze the input image of the filled form and may extract information from the filled form. This information may have been part of the filled form as handwritten text or checkboxes. For example, if the filled form includes checkboxes for gender, the model may output “Female: selected, Male: unselected.” For filled forms including handwritten responses, an OCR system may pull out text and handwritten text. The document model may be trained to process the input image and take out the text that has been filled in. The document model may output semi-structured OCR or text.

At step 307, a machine learning model (such as an LLM) may extract text from the image according to the selected schema (e.g., from step 306) and the text of the image (e.g., output of step 305). The selected schema, image of the filled form, and document model OCR/text may be input to the LLM. The output of the LLM may be data obtained from the filled form (e.g., data from the image and OCR according to the schema). The LLM of step 307 may be a multi-modal LLM where modalities include text, sound, image, etc. The LLM may process the input image, for example by converting the input image into text. The text may then be encoded into a string, which may then be turned int a matrix of pixel values.

The LLM may match or associated response text strings of the filled form to header text strings of the filled form. For example, if the response text “Brooklyn” is located near the header “Name,” then the response text “Brooklyn” may be identified as a name, as opposed to being identified as an address or residence. When extracting information, step 307 may also filter text from the image to remove unwanted or unnecessary text. For example, step 307 may remove unanswered questions, extra text, unnecessary information, etc. The output data 308 obtained from the filled form may thus be more relevant, easier to read, and digitized in structured form for further processing.

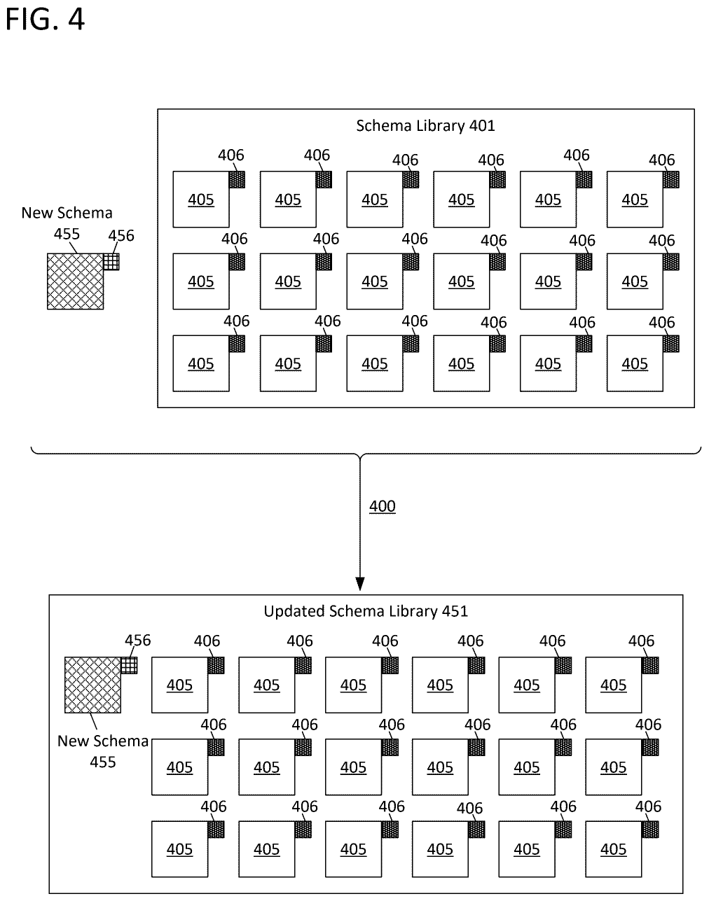

FIG. 4 depicts process 400 of adding new schema 455 to schema library 401 to form updated schema library 451. Each schema 405 includes an associated schema index 406. One or more schemas 405 may be added to schema library 401 as part of a setup stage, and one or more schemas 405 may be added to schema library 401 after a first setup stage as part of a secondary or repeating setup stage. That is, schemas may be added to a schema library before and after data is obtained from a filled form without retraining any machine learning models based on the added schemas.

A schema library generator model may generate schemas 405 and indexes 406. Schemas 405 may be encoded as vectors using an embedding algorithm. The embedding algorithm can be embodied in a machine learning model such as an LLM. The embedding vectors may be tagged, labeled, or otherwise include reference to corresponding schemas 405 that the embedding vectors describe. A set of embedding vectors may act as an index 406 to a schema 405. Each schema 405 may correspond to a specific unfilled form.

New schema 455 and its corresponding new index 456 may be generated later than schemas 405 and their indexes 406. For example, new schema 455 and new index 456 may be generated (e.g., by the schema library generator model) after data has been extracted from a form based on one of the schemas 405. New schema 455 and new index 456 may be generated without retraining the schema library generator model. New schema 455 may be encoded as vectors using an embedding algorithm. The embedding vectors may be tagged, labeled, or otherwise include reference to new schema 455. A set of one or more embedding vectors may act as new index 456 to new schema 455.

After new schema 455 and new index 456 are generated, they may be added to schema library 401 to create updated schema library 451. Schema 405 may correspond to a specific unfilled form. In specific embodiments, new schema 455 may be a new type of form, may be an alternate version of a form, or may be an updated version of a previous form (e.g., resulting in new schema 455 being an updated version of a schema 405).

Process 400 of adding new schema 455 to schema library 401 to create updated schema library 451 may improve data extraction by increasing accuracy of extracting data and increasing long term applicability. For example, a workflow may easily be updated to accommodate new forms such as purchase orders or checks from a new affiliate or forms that have been updated from old versions.

Process 400 allows for changing forms (e.g., updated, new versions, additional forms) without retraining a machine learning model.

Instead, a schema generated by a schema library generator model is added to the schema library. Accordingly, the overall data extraction system decreases cost and is more efficient through the execution of a single inference per additional form (as opposed to the numerous training inferences required to train a prior art form data extraction model for a specific form, and the overhead associated with a training session generally).

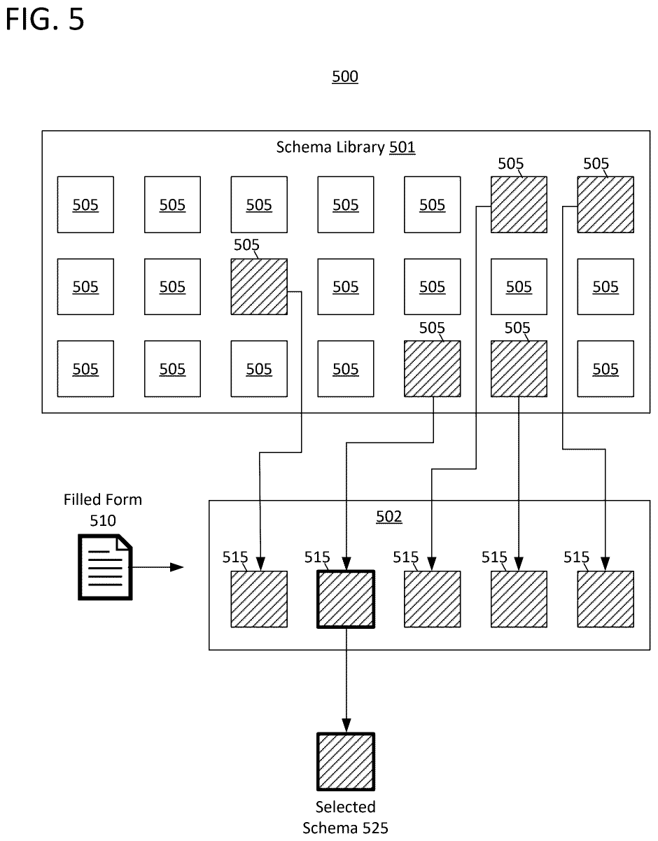

FIG. 5 depicts process 500 of selecting schema 525 from a set of candidate schemas 515. Schema library 501 includes schemas 505. Schema library 501 may include any number of schemas, although 21 are shown. Schema selection machine learning model 502 may receive any number of candidate schemas 515, although five are shown.

A machine learning model of an embedding vector may generate a binary encoded vector for filled form 510. The binary encoded vector may then be used in a vector similarity search (e.g., nearest neighbor analysis) to find candidate schemas 515 that closely match filled form 510. The schemas indexes used in the vector similarity search can be encoded aby an embedding algorithm. Many forms have titles and field names that are the same (e.g., consistent) regardless of the information (e.g., user data) entered into the form. This similarity allows an approximate nearest neighbor search to find candidate schemas 515 for filled form 510. A schema identification model may send the set of candidate schemas 515 to schema selection machine learning model 502.

Schema selection machine learning model 502 may receive the set of candidate schemas 515 and an image of filled form 510. Schema selection machine learning model 502 may analyze which candidate schema 515 most closely fits filled form 510 based on the encoding of the raw image representing the filled form 510 and choose that candidate schema 515 to be selected schema 525. Selected schema 525 may be input to a form data extraction model and data may be extracted from filled form 510 in accordance with selected schema 525.

Selected schema 525 improves accuracy for extracting data from filled form 510. Different forms often use different headings for the same information, so by using the correct schema for the filled form, the form data extraction model may be able to identify which heading to look for. For example, selected schema 525 might indicate that “residence” is a heading, opposed to “address”. Selected schema 525 may tell the form data extraction model what to look for in filled form 510 and may therefore make the act of extracting information from filled form 510 (and filled forms generally) more consistent. Additionally, selected schema 525 may be valuable as selected schema 525 provides more guidance for the form data extraction model, which may perform better with a specific task rather than a general task.

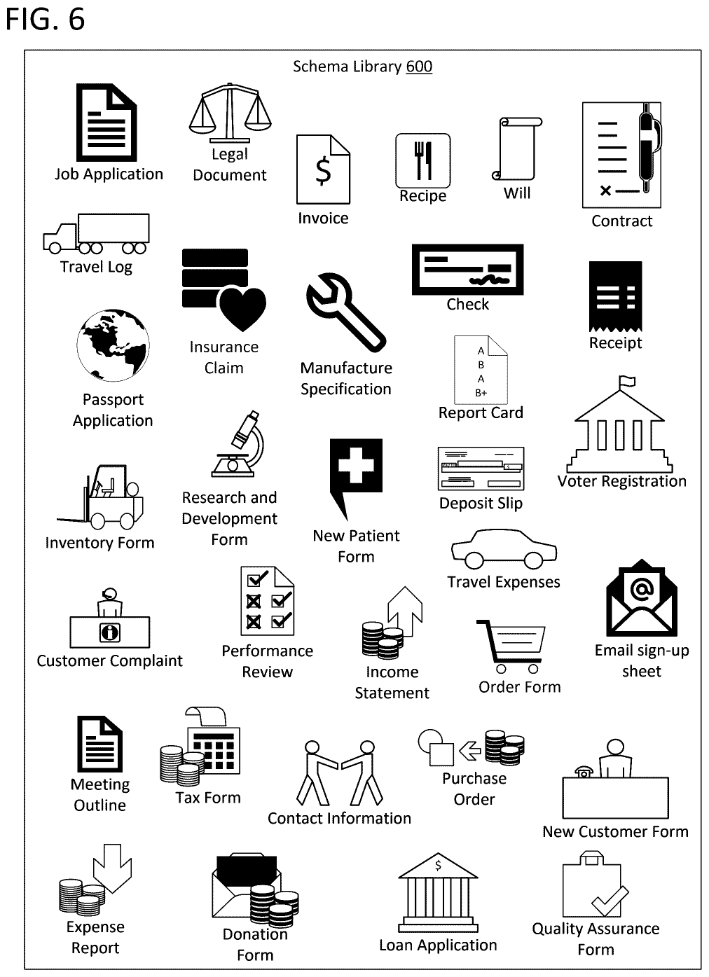

FIG. 6 shows examples of unfilled forms that schemas in schema library 600 may be based on. Schema library 600 may refer to many types of forms, including different versions of the same form, updated forms, and new forms. Schema library 600 may be updated to include additional schemas for additional forms.

In specific embodiments, schema library 600 may include schemas for job applications, legal documents, invoices, recipes, wills, contracts, passport applications, report cards, insurance claims, manufacturing specifications, checks, receipts, travel logs, inventory forms, research and development forms, new patient forms, deposit slips, voter registration forms, travel expense reimbursement forms, customer complaint forms, performance reviews, income statements, order forms, email sign-up sheets, meeting outlines, tax forms, contact information, purchase orders, new customer forms, expense reports, donation forms, loan applications, quality assurance forms, or a combination thereof. These examples of forms are exemplary only, and schema library 600 may include schemas associated with additional forms not listed. In specific embodiments, schema library 600 may include multiple schemas associated with different versions of a form.

Unfilled forms associated with schema library 600 may correspond to filled forms that may be processed at another time. Filled forms may be an image of a handwritten document, typed document, or a mixture of handwriting and type, and may be separated into individual pages (e.g., when a form constitutes multiple pages). Filled forms may not be formatted consistently (e.g., mix of type and handwritten entries, mix of checkboxes and sentence responses, etc.). Unfilled forms which may be digitized or otherwise be simpler for a machine language model to analyze.

Many kinds of information may be gathered from filled forms corresponding to schemas of schema library 600. For example, extracted data may include information such as names, ages, phone numbers, addresses, dates, birthdays, emails, genders, preferred pronouns, identification numbers, case numbers, contract terms, incomes, tax brackets, tax deductions, account numbers, ordered items, medical symptoms, family medical history, prescribed medications, insurance information, emergency contact information, allergy information, dietary restrictions, insurance policies, maintenance requests, bill amounts, and more.

Specific embodiments of inventions described herein may allow fast and easy extraction of data from filled forms. Specific embodiments may allow expandable schema databases without expensive and time-consuming retraining of machine learning models. Workflows for a large variety of businesses and enterprises may be improved.

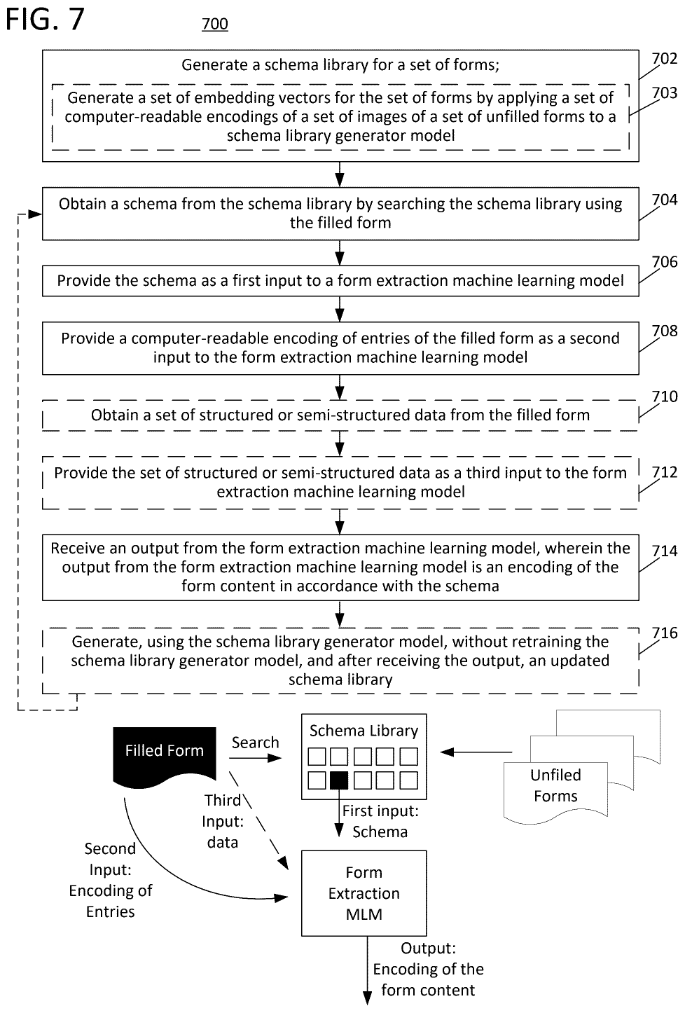

FIG. 7 depicts an example of semantic form processing method 700 for extracting form content from a filled form. Each step of method 700 may be computer-implemented. Method 700 may be implemented by a system including one or more non-transitory computer-readable media storing instructions, one or more processors, at least one unfilled form (e.g., form template), and at least one filled form corresponding to the at least one unfilled form. Method 700 may also be implemented by a system including means for performing each step of method 700. Steps, or portions of steps, of method 700 may be omitted, duplicated, rearranged, or otherwise deviate from the order shown.

At step 702, a schema library for a set of forms may be generated. In specific embodiments, the set of forms may include a receipt, check, tax form, invoice, purchase order, contract, insurance claim, or legal document. Both filled forms and unfilled forms may refer to these types of forms.

In specific embodiments, and as part of generating the schema library (step 702), at step 703, a set of embedding vectors for the set of forms may be generated. The set of embedding vectors for the set of forms may be generated by applying a set of computer-readable encodings of a set of images and a set of unfilled forms to a schema library generator model.

At step 704, a schema may be obtained from the schema library. The schema may be obtained by searching the schema library using the filled form. In specific embodiments, schema may be stored using extensible markup language (XML) schema definitions or document type definitions. The schema may be manipulated using XML path language or XML query.

At step 706, the schema (e.g., obtained at step 704) may be provided as a first input to a form extraction machine learning model.

In specific embodiments, at step 708, a computer-readable encoding of entries of the filled form may be provided as a second input to the form extraction machine learning model. In specific embodiments, the computer-readable encoding of the entries of the filled form may comprise a textual encoding of an image of the filled form. In specific embodiments, the image of the filled form is one of a Joint Photographic Experts Group (JPEG) image, a Portable Network Graphics (PNG) image, a Graphics Interchange Format (GIF) image, a Bitmap (BMP) image, or a Scalable Vector Graphics (SVG) image. In specific embodiments, the computer-readable encoding of the entries of the filled form is a textual encoding of an image of the filled form (e.g., a binary or alphanumeric encoding of values, such as pixels, that represent the image).

In specific embodiments, at step 710, a set of structured or semi-structured data may be obtained from the filled form. In specific embodiments, the schema and the set of structured or semi-structured data are in text format and are human-readable.

In specific embodiments, at step 712, the set of structured or semi-structured data (e.g., obtained at step 710) may be provided as a third input to the form extraction machine learning model.

At step 714, an output from the form extraction machine learning model may be received. The output from the form extraction machine learning model may be an encoding of the form content in accordance with the schema. In specific embodiments, the output from the form extraction machine learning model may use the first input (e.g., from step 706), the second input (e.g., from step 708), and the third input (e.g., from step 712). In specific embodiment, the output from the form extraction machine learning model is in a structured JSON format.

In specific embodiments, at step 716, an updated schema library may be generated. The updated schema library may be generated using the schema library generator model, without retraining the schema library generator model, and after receiving the output (e.g., step 714). The updated schema library may include an additional schema generated using an unfilled (e.g., template) version of an additional form and the schema library generator model.

In specific embodiments, steps or portions of steps of method 700 may be repeated. For example, after step 716 (or step 714), one or more of steps 704 through 716 may be repeated. Step 704 may be repeated with a second schema and a second filled form. Step 706 may be repeated with the second schema being an additional (e.g., third, fourth) input to the form extraction machine learning model. Step 708 may be repeated with a computer readable encoding of second entries of the second filled form as an additional (e.g., fourth, fifth) input to the form extraction machine learning model. Step 714 may be repeated with a second output from the form extraction machine learning model, with the second output being an encoding of second form content in accordance with the second schema.

The system that implements method 700 may include various means for performing steps of method 700. For example, generating a schema library for a set of forms (step 702), generating a set of embedding vectors (step 703), searching the schema library (e.g., part of step 704), obtaining a set of structured or semi-structured data from the filled form (step 710), and generating an updated schema library (step 716) may be performed by one or more machine learning models, LLMs, etc. As another example, obtaining a schema from the library of schemas (e.g., part of step 704), providing the schema as a first input (step 706), providing a computer-readable encoding of entries of the filled form as a second input (step 708), providing the set of structured or semi-structured data as a third input (step 712), and receiving an output from the form extraction machine learning model (step 714) may be performed by wires, busses, wireless communication, ports, antennas, etc.

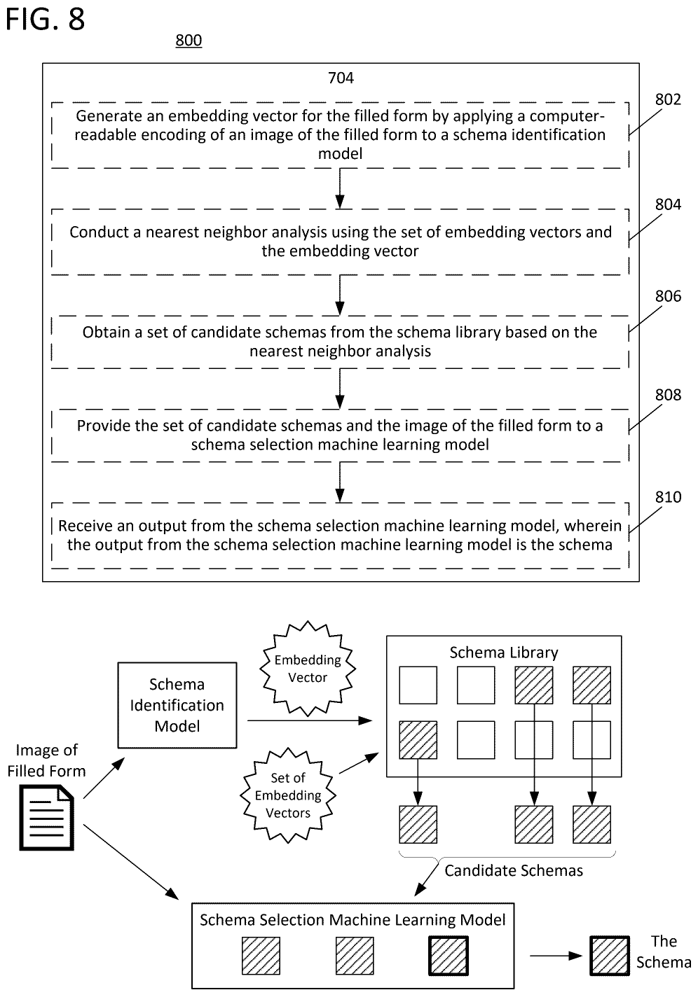

FIG. 8 depicts an example of method 800 for obtaining a schema from a schema library. Each step of method 800 may be computer-implemented. Method 800 may be implemented by a system including one or more non-transitory computer-readable media storing instructions, one or more processors, at least one unfilled form (e.g., form template), and at least one filled form corresponding to the at least one unfilled form. Method 800 may also be implemented by a system including means for performing each step of method 800. Method 800 may be implemented by the same system that implements method 700. Steps, or portions of steps, of method 800 may be omitted, duplicated, rearranged, or otherwise deviate from the order shown. Method 800 may be a part of or a continuation of method 700.

Step 704 may be the same as step 704 of method 700. For example, a schema may be obtained from the schema library. The schema may be obtained by searching the schema library using a filled form.

At step 802 (and as part of step 704), an embedding vector for the filled form may be generated. The embedding vector may be generated by applying a computer-readable encoding of an image of the filled form to a schema identification model.

At step 804 (and as part of step 704), a nearest neighbor analysis may be conducted using the set of embedding vectors (e.g., from step 703) and the embedding vector (e.g., from step 802).

At step 806 (and as part of step 704), a set of candidate schemas from the schema library may be obtained based on the nearest neighbor analysis (e.g., conducted at step 804).

At step 808 (and as part of step 704), the set of candidate schemas and the image of the filled form may be provided to a schema selection machine learning model.

At step 810 (and as part of step 704), an output from the schema selection machine learning model may be received. The output form the schema selection machine learning model may be the schema obtained by step 704 and provided as a first input at step 706 of method 700.

The system that implements method 800 may include various means for performing steps of method 800. For example, generating an embedding vector (step 802), conducting a nearest neighbor analysis (step 804), and obtaining a set of candidate schemas (step 806) may be performed by one or more machine learning models, LLMs, etc. As another example, providing the set of candidate schemas and the image of the filled form to a schema selection machine learning model (step 808) and receiving an output from the schema selection machine learning model (step 810) may be performed by wires, busses, wireless communication, ports, antennas, etc.

Methods 700 and 800 may allow increased efficiency in extracting data from forms, especially forms that are at least partially handwritten. Methods 700 and 800 do not require large amounts of training data (examples of filled or unfilled forms) to any of the one or more machine learning models. The one or more machine learning models also do not need to be retrained to add new schemas to the schema library or to find data associated with a new form or new form type. Methods 700 and 800 do not require large amounts of preprocessing, as images of filled and unfilled forms may be directly input into one or more machine learning models in specific embodiments. Methods 700 and 800 may extract data from forms that may otherwise be difficult to extract data from, for example forms with handwritten responses, checkboxes, or less structured organization.

At least one processor in accordance with this disclosure can include at least one non-transitory computer readable media. The media could include cache memories on the processor. The media can also include shared memories that are not associated with a unique computational node. The media could be a shared memory, could be a shared random-access memory, and could be, for example, a double data rate (DDR) dynamic random-access memory (DRAM). The shared memory can be accessed by multiple channels. The non-transitory computer readable media can store data required for the execution of any of the methods disclosed herein, the instruction data disclosed herein, and/or the operand data disclosed herein. The computer readable media can also store instructions which, when executed by the system, cause the system to execute the methods disclosed herein. The concept of executing instructions is used herein to describe the operation of a device conducting any logic or data movement operation, even if the “instructions” are specified entirely in hardware (e.g., an AND gate executes an “and” instruction). The term is not meant to impute the ability to be programmable to a device.

While the specification has been described in detail with respect to specific embodiments of the invention, it will be appreciated that those skilled in the art, upon attaining an understanding of the foregoing, may readily conceive of alterations to, variations of, and equivalents to these embodiments. Any of the method steps discussed above can be conducted by a processor operating with a computer-readable non-transitory medium storing instructions for those method steps. The computer-readable medium may be memory within a personal user device or a network accessible memory. Although examples in the disclosure where generally directed to forms with handwritten inputs, the same approaches could be utilized to extract data from media containing information in the form of graphics, sound, video, etc. These and other modifications and variations to the present invention may be practiced by those skilled in the art, without departing from the scope of the present invention, which is more particularly set forth in the appended claims.

What is claimed is:

1. A semantic form processing method to extract form content from a filled form, in which each step is computer-implemented, comprising:
generating a schema library for a set of forms;
obtaining a schema from the schema library by searching the schema library using the filled form;
providing the schema as a first input to a form extraction machine learning model;
providing a computer-readable encoding of entries of the filled form as a second input to the form extraction machine learning model; and
receiving an output from the form extraction machine learning model, wherein the output from the form extraction machine learning model is an encoding of the form content in accordance with the schema.

2. The semantic form processing method of claim 1, wherein:
searching the schema library includes generating an embedding vector for the filled form by applying a computer-readable encoding of an image of the filled form to a schema identification model.

3. The semantic form processing method of claim 1, wherein:
the computer-readable encoding of the entries of the filled form comprises a textual encoding of an image of the filled form.

4. The semantic form processing method of claim 1, further comprising:
obtaining a set of structured or semi-structured data from the filled form; and
providing the set of structured or semi-structured data as a third input to the form extraction machine learning model;
wherein the output from the form extraction machine learning model is generated by the form extraction machine learning model using the first input, the second input, and the third input.

5. The semantic form processing method of claim 4, wherein:
the schema and the set of structured or semi-structured data are in text format and are human-readable; and
the computer-readable encoding of the entries of the filled form is a textual encoding of an image of the filled form.

6. The semantic form processing method of claim 1, wherein:
generating the schema library includes generating a set of embedding vectors for the set of forms by applying a set of computer-readable encodings of a set of images of a set of unfilled forms to a schema library generator model.

7. The semantic form processing method of claim 6, further comprising:
generating, using the schema library generator model, without retraining the schema library generator model, and after receiving the output, an updated schema library;
wherein the updated schema library includes an additional schema generated using an unfilled version of an additional form and the schema library generator model.

8. The semantic form processing method of claim 6, wherein searching
the schema library comprises:
generating an embedding vector for the filled form by applying a computer-readable encoding of an image of the filled form to a schema identification model; and
conducting a nearest neighbor analysis using a set of embedding vectors and the embedding vector.

9. The semantic form processing method of claim 8, wherein obtaining the schema from the schema library comprises:
obtaining a set of candidate schemas from the schema library based on the nearest neighbor analysis;
providing the set of candidate schemas and the image of the filled form to a schema selection machine learning model; and
receiving an output from the schema selection machine learning model, wherein the output from the schema selection machine learning model is the schema.

10. The semantic form processing method of claim 1, wherein:
the schema is stored using extensible markup language schema definitions or document type definitions; and
the schema is manipulated using extensible markup language path language or extensible markup language query.

11. The semantic form processing method of claim 1, further comprising:
obtaining a second schema from the schema library by searching the schema library using a second filled form;
providing the second schema as a third input to the form extraction machine learning model;
providing a computer-readable encoding of second entries of the second filled form as a fourth input to the form extraction machine learning model; and
receiving a second output from the form extraction machine learning model, wherein the second output from the form extraction machine learning model is an encoding of second form content in accordance with the second schema.

12. The semantic form processing method of claim 1, wherein:
the filled form is a receipt, check, tax form, invoice, purchase order, contract, insurance claim, or legal document.

13. The semantic form processing method of claim 1, wherein:
the computer-readable encoding of the entries of the filled form comprises a textual encoding of an image of the filled form; and
the image of the filled form is one of a Joint Photographic Experts Group (JPEG) image, a Portable Network Graphics (PNG) image, a Graphics Interchange Format (GIF) image, a Bitmap (BMP) image, or a Scalable Vector Graphics (SVG) image.

14. The semantic form processing method of claim 1, wherein:
the output from the form extraction machine learning model is in a structured javascript object notation format.

15. One or more non-transitory computer-readable media storing instructions, which when executed by one or more processors cause the one or more processors to conduct a method to extract form content from a filled form, in which each step is computer-implemented, the method comprising:
generating a schema library for a set of forms;
obtaining a schema from the schema library by searching the schema library using the filled form;
providing the schema as a first input to a form extraction machine learning model;
providing a computer-readable encoding of entries of the filled form as a second input to the form extraction machine learning model; and
receiving an output from the form extraction machine learning model, wherein the output from the form extraction machine learning model is an encoding of the form content in accordance with the schema.

16. The one or more non-transitory computer-readable media of claim 15, wherein:
searching the schema library includes generating an embedding vector for the filled form by applying a computer-readable encoding of an image of the filled form to a schema identification model.

17. The one or more non-transitory computer-readable media of claim 15, wherein:
the computer-readable encoding of the entries of the filled form comprises a textual encoding of an image of the filled form.

18. A system for extracting form content from a filled form, in which each step is computer-implemented, comprising:
a means for generating a schema library for a set of forms;
a means for obtaining a schema from the schema library by searching the schema library using the filled form;
a means for providing the schema as a first input to a form extraction machine learning model;
a means for providing a computer-readable encoding of entries of the filled form as a second input to the form extraction machine learning model; and
a means for receiving an output from the form extraction machine learning model, wherein the output from the form extraction machine learning model is an encoding of the form content in accordance with the schema.

19. The system of claim 18, wherein:
searching the schema library includes generating an embedding vector for the filled form by applying a computer-readable encoding of an image of the filled form to a schema identification model.

20. The system of claim 18, wherein:
the computer-readable encoding of the entries of the filled form comprises a textual encoding of an image of the filled form.
